(19) United States
(12) Patent Application Publication
(10) Pub. No.: US 2025/0331651 A1
(43) Pub. Date: Oct. 30, 2025

(54) METHOD OF MAKING STRING OF SPRINGS FOR USE IN POCKETED SPRING ASSEMBLY

(71) Applicant: L&P Property Management Company, South Gate, CA (US)

(72) Inventors: Bruce W. Peterson, Austin, TX (US); Takayuki Hironaka, Fort Smith, AR (US)

(73) Assignee: L&P Property Management Company, South Gate, CA (US)

(21) Appl. No.: 18/645,894

(22) Filed: Apr. 25, 2024

(51) Int. Cl. A47C 27/05; A47C 27/06; A47C 27/07; B68G 7/06

(52) U.S. Cl. CPC A47C 27/053; A47C 27/064; A47C 27/07; B68G 7/06

(57) ABSTRACT

A method of making a string of springs for use in a pocketed spring assembly comprises folding one piece of fabric into first and second opposed plies of fabric. An oversized pocket is formed along each string by transverse seams joining the first and second plies. The oversized pocket is separated into a spring pocket and a mini-pocket by a separating seam. A coil spring is positioned in each spring pocket. Foam chemicals are injected into the mini-pocket. The foam chemicals react in the mini-pocket to create a foam pad.

### FIELD OF THE INVENTION

This invention relates generally to pocketed spring assemblies used in bedding and seating products and, more particularly, to methods used to make strings of springs for use in pocketed spring assemblies.

### BACKGROUND OF THE INVENTION

Mattress spring core construction over the years has been a continuously improving art with advancements in materials and machine technology. A well-known form of spring core construction is known as a Marshall spring construction wherein metal coil springs are encapsulated in individual pockets of fabric and formed as elongate or continuous strings of pocketed coil springs. In an earlier form, these strings of coil springs were manufactured by folding an elongate piece of fabric in half lengthwise to form two plies of fabric and stitching transverse and longitudinal seams to join the plies of fabric to define pockets within which the springs were enveloped.

More recently, improvements in spring core constructions have involved the use of fabrics which are thermally or ultrasonically weldable to themselves. By using such welding techniques, these fabrics have been advantageously used to create strings of individually pocketed coil springs wherein transverse and longitudinal welds, instead of stitching, are used to form the pockets encapsulating the springs.

Once strings of pocketed springs are constructed, they may be assembled to form a pocketed spring core or assembly for a mattress, cushion or the like by a variety of methods. For example, multiple or continuous strings may be arranged in a row pattern corresponding to the desired size and shape of a mattress or the like, and adjacent rows of springs may be interconnected by a variety of methods. The result is a unitary assembly of pocketed coil springs serving as a complete spring core assembly.

Conventional pocketed spring cores incorporating pocketed strings of springs have less motion transfer between sleeping partners when compared to traditional helically-laced open coil spring assemblies. Each pocketed coil spring is able to move with greater independence and, therefore provide less influence on adjacent pocketed coil springs than if the coil springs were not inside individual pockets. However, with a traditional pocketed spring mattress, a sheet of foam or other cushioning layer is attached to an upper surface of the pocketed spring assembly. The foam or cushioning sheet or sheets acts like a bridge, such that a load applied to one side of a mattress affects the other side of the mattress, providing an undesirable bridging effect. The present invention eliminates the undesirable bridging effect by encapsulating individual cushion/foam members inside outer pockets of strings of springs.

U.S. Pat. No. 6,490,744 discloses a pocketed spring assembly incorporating strings which have individually pocketed coil springs with cushioning pads inside the pockets. However, due to the individual coil springs being un-pocketed, the coil springs may damage the cushioning pads and/or affect the feel of the pocketed spring assembly due to the coil springs pressing against the cushioning pads. The capability of the individually pocketed springs to act independently from the adjacent pocketed springs in the string of springs may be compromised.

U.S. Pat. No. 10,842,289 discloses a pocketed spring assembly incorporating strings which have individually pocketed coil springs with cushioning pads inside outer pockets. The foam pads remain separate from the inner pocketed coil springs, prolonging the useful life of the foam pads. However, manufacturing such strings of springs may be difficult due to the necessity of handling individual foam pads and securing them in their proper locations.

Therefore, there remains a need for a manufacturing method for making strings of springs for use in pocketed spring assemblies which is less costly than heretofore known methods.

There is also a need for a manufacturing method for making pocketed spring assemblies which allows foam to be injected into empty mini-pockets of strings of pocketed springs.

### SUMMARY OF THE INVENTION

In one aspect, a method of making a string of springs for use in a pocketed spring assembly is provided. The method comprises wrapping a piece of fabric around a plurality of springs. The method further comprises joining the piece of fabric to itself with a longitudinal seam, first and second opposed plies of fabric being on opposite sides of the springs. A plurality of pockets is formed along the length of the string by the longitudinal seam and transverse seams joining the first and second plies. At least one spring is in each of the pockets. Each spring is preferably a coil spring and may be any desired size or shape.

The method further comprises welding the first and second opposed plies of fabric together to create spring pockets containing the springs and mini-pockets.

The method further comprises injecting foam chemicals in each of the mini-pockets through the fabric and allowing the foam chemicals to react in the mini-pocket to create a foam pad within the mini-pocket. The foam chemicals include polyols, water, silicone surfactant, amine catalyst, tin catalyst and isocyanate. Additives that may also be included in the foam chemicals and injected into each of the empty mini-pockets include, but are not limited to, one or more particulates, powders or fibers of graphite, expandable graphite, microencapsulated phase-change material, diamond, synthetic diamond, silicone carbide, carbon fiber, carbon nanotubes, graphene, aluminum, copper, iron, steel, silver, gold, platinum, nickel, tin, chromium, vanadium, tungsten, and the like.

The strings may extend longitudinally (from end-to-end) or transversely (from side-to-side). A pocketed spring assembly for use in a bedding or seating product may be posturized into regions or zones of different firmness by incorporating different strings into the pocketed spring assembly.

If the strings extend transversely, the pocketed spring assembly may include a plurality of the strings having a particular foam pad in the pockets and other strings having different foam pads, the strings arranged in a plurality of zones longitudinally spaced apart. For example, the pocketed spring assembly may include three such zones. The three zones may comprise a central zone, a head end zone and a foot end zone. The end zones may comprise strings having one type of foam pad, and the strings comprising central zone may comprise strings having different foam pads.

If the strings extend longitudinally, the pocketed spring assembly may include strings having one type of foam pad in the pockets and other strings having different foam pads, the strings arranged in a plurality of zones transversely spaced apart. For example, the pocketed spring assembly may include two such zones, a “his” side and a “hers” side.

In another aspect, another method of making a string of springs for use in a pocketed spring assembly is provided. The method comprises wrapping a piece of fabric around a plurality of coil springs and joining the piece of fabric to itself with a longitudinal seam. First and second opposed plies of fabric are formed on opposite sides of the springs. Each coil spring may be any desired size or shape with any number of convolutions.

The method further comprises welding the first and second opposed plies of fabric together along transverse seams to create a plurality of oversized pockets, a coil spring being in each of the oversized pockets.

The method further comprises welding the first and second opposed plies of fabric together in a direction parallel the longitudinal seam to create separating seams, thereby separating the oversized pocket into a spring pocket and a mini-pocket. The coil spring is in the spring pocket and the mini-pocket is empty.

The method further comprises injecting a mixture of foam chemicals in each of the mini-pockets through the fabric and allowing the mixture of foam chemicals to react in the mini-pocket to create a foam pad within the mini-pocket. The foam chemicals include polyols, water, silicone surfactant, amine catalyst, tin catalyst and isocyanate. Additives may also be included in the mixture injected into each of the mini-pockets.

In another aspect, another method of making a string of springs for use in a pocketed spring assembly is provided. The method comprises wrapping a piece of fabric around a plurality of springs and joining the piece of fabric to itself with a longitudinal seam. First and second opposed plies of fabric are on opposite sides of the springs. Each spring may be a coil spring of any desired size or shape with any number of convolutions.

The method further comprises welding the first and second opposed plies of fabric together to create transverse seams, the transverse seams separating the piece of fabric into a plurality of oversized pockets, a spring being in each of the oversized pockets.

The method further comprises welding the first and second opposed plies of fabric together to create separating seams, thereby separating the oversized pocket into a spring pocket and an empty mini-pocket. The spring is in the spring pocket. Creating the separating seams comprises welding the first and second opposing plies of fabric together in a direction parallel the longitudinal seam.

The method further comprises injecting foam chemicals in each of the mini-pockets through the fabric and allowing the mixture of foam chemicals to react in the mini-pocket to create a foam pad within the mini-pocket. The foam chemicals include polyols, water, silicone surfactant, amine catalyst, tin catalyst and isocyanate. Additives may also be included in the foam chemicals injected into each of the mini-pockets.

One advantage of the method of the present invention is that when a string of springs is manufactured for use in a pocketed spring assembly, the manufacturer need not handle prefabricated foam members or pads. The mattress manufacturer may simply inject a desired mixture of foam chemicals into each mini-pocket of a string without handling foam pads or members.

Another advantage of the method of the present invention is that the pocketed coil spring does not press into a foam pad above/below it when subjected to a load. Because the coil spring is retained in its own mini-pocket independent of the foam pad or pads, the spring does not contact the foam pad or pads, thereby preserving the designed characteristics of the foam pad or pads such as firmness, for example. The spring pockets of fabric surrounding the coil springs and/or the fabric surrounding each foam pad preserves the integrity of the foam pads and increases the life of the pocketed spring assembly. The result is that the user “feels” more of the foam pad or pads.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is a perspective view, partially broken away, of a bedding or seating product incorporating a one-sided pocketed spring assembly according to the principles of the invention.

FIG. 1A is a perspective view, partially broken away, of a bedding or seating product incorporating a two-sided pocketed spring assembly.

FIG. 2 is a perspective view, partially broken away, of a portion of a string of springs of FIG. 1 in an unloaded condition.

FIG. 3A is a cross-sectional view, partially broken away, of a portion of a string of FIG. 2 in an unloaded condition.

FIG. 3B is a cross-sectional view, partially broken away, of a portion of the string of FIG. 3A having its oversized pockets being welded and having injector nozzles being lowered into the mini-pockets.

FIG. 3C is a cross-sectional view, partially broken away, of the portion of the string of FIG. 3B having injector nozzles injecting mixture into the mini-pockets.

FIG. 3D is a cross-sectional view, partially broken away, of the portion of the string of FIG. 3C the injector nozzles having been removed and the chemical mixtures hardening in the mini-pockets.

FIG. 4A is a cross-sectional view taken along the line 4A-4A of FIG. 3A showing welding plates coming together.

FIG. 4B is a cross-sectional view taken showing the welding plates together, creating one of the separating seams.

FIG. 4C is a cross-sectional view, like FIG. 4B, but showing one of the injector nozzles injecting a chemical mixture into one of the mini-pockets.

FIG. 4D is a cross-sectional view, like FIG. 4C, but showing one of the mini-pockets being filled with foam.

FIG. 5A is a cross-sectional view, partially broken away, of the portion of a double-sided string of FIG. 1A having injector nozzles in the mini-pockets before mixture flows through the injector nozzles.

FIG. 5B is a cross-sectional view, partially broken away, of the portion of a double-sided string of FIG. 5A having mini-pockets filled with foam.

FIG. 6 is a schematic view of a process of creating the mixture of chemicals.

FIG. 7 is a schematic view of an apparatus for injecting the mixture of chemicals into the mini-pockets.

FIG. 8 is a top view of a posturized pocketed spring assembly.

FIG. 9 is a top view of another posturized pocketed spring assembly.

### DETAILED DESCRIPTION OF THE INVENTION

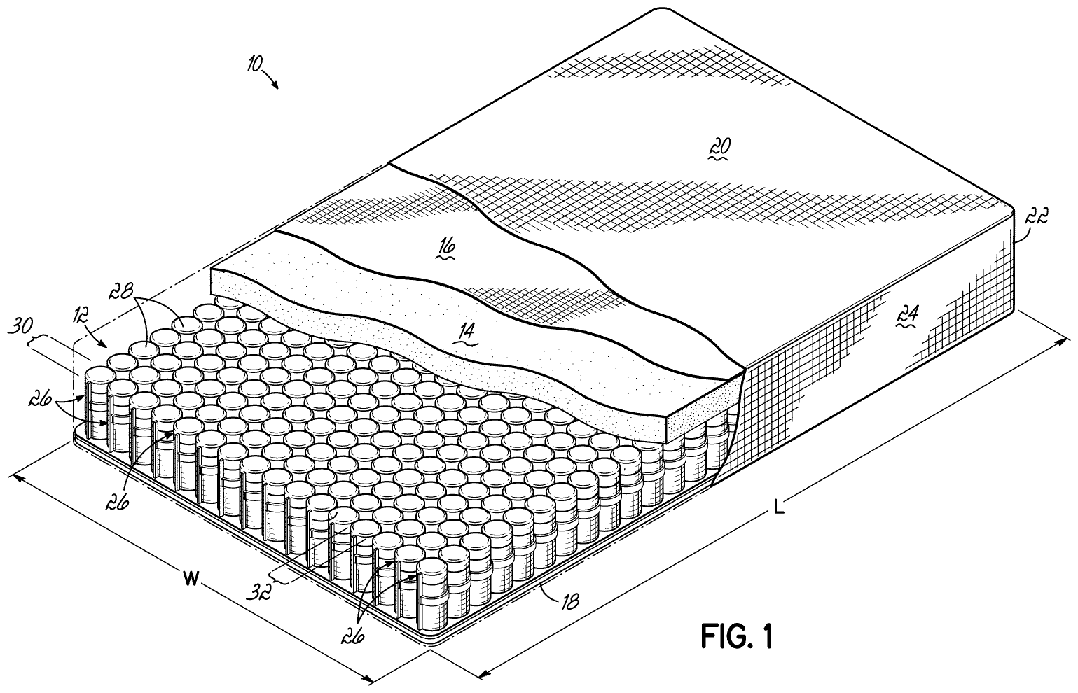

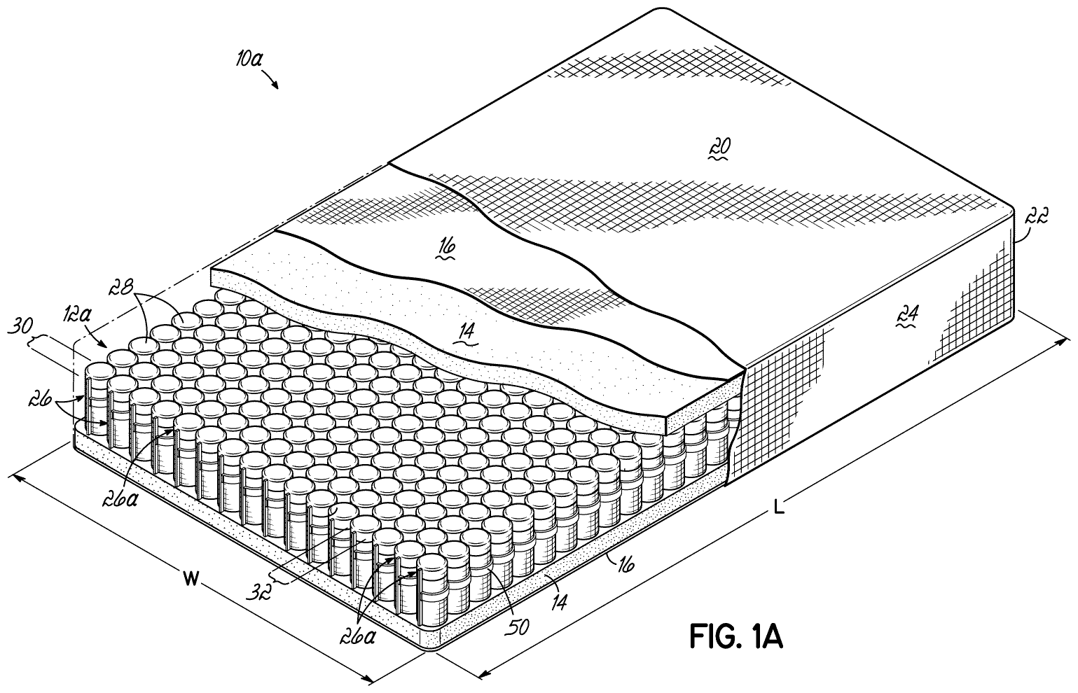

Referring first to FIG. 1, there is illustrated a bedding product in the form of a single-sided mattress 10 incorporating the principles of the present invention. This product or mattress 10 comprises a pocketed spring assembly 12 over the top of which there lay conventional padding or cushioning layers 14, 16 which may be foam, fiber, gel, a pocketed spring blanket or any other suitable materials or any combination thereof. The pocketed spring assembly 12 may be surrounded with a border made of foam or pocketed coil springs. The pocketed spring assembly 12 is mounted upon a base 18 and is completely enclosed within an upholstered covering material 20. The base 18 may be rigid made of plastic or wood. Alternatively, the base 18 may be flexible such as a scrim sheet or a sheet such those disclosed in U.S. Pat. Nos. 11,013,340 and 11,812,860 and U.S. Patent Publication No. 2023/0270262, which are each incorporated by reference herein.

As shown in FIG. 1, fully assembled, the product 10 has a length “L” defined as the linear distance between opposed end surfaces 22 (only one being shown in FIG. 1). Similarly, the assembled product 10 has a width “W” defined as the linear distance between opposed side surfaces 24 (only one being shown in FIG. 1). In the product shown in FIG. 1, the length is illustrated as being greater than the width. However, it is within the scope of the present invention that the length and width may be identical, as in a square product.

As shown in FIG. 1, pocketed spring assembly 12 is manufactured from multiple strings 26 of pocketed springs 28 joined together. Each string of pocketed springs 26 extends longitudinally or from head-to-foot along the full length of the product 10. Although the strings of pocketed springs 26 are illustrated as extending longitudinally or from head-to-foot in the pocketed spring assembly 12 of FIG. 1, they may extend transversely or from side-to-side in the pocketed spring assembly.

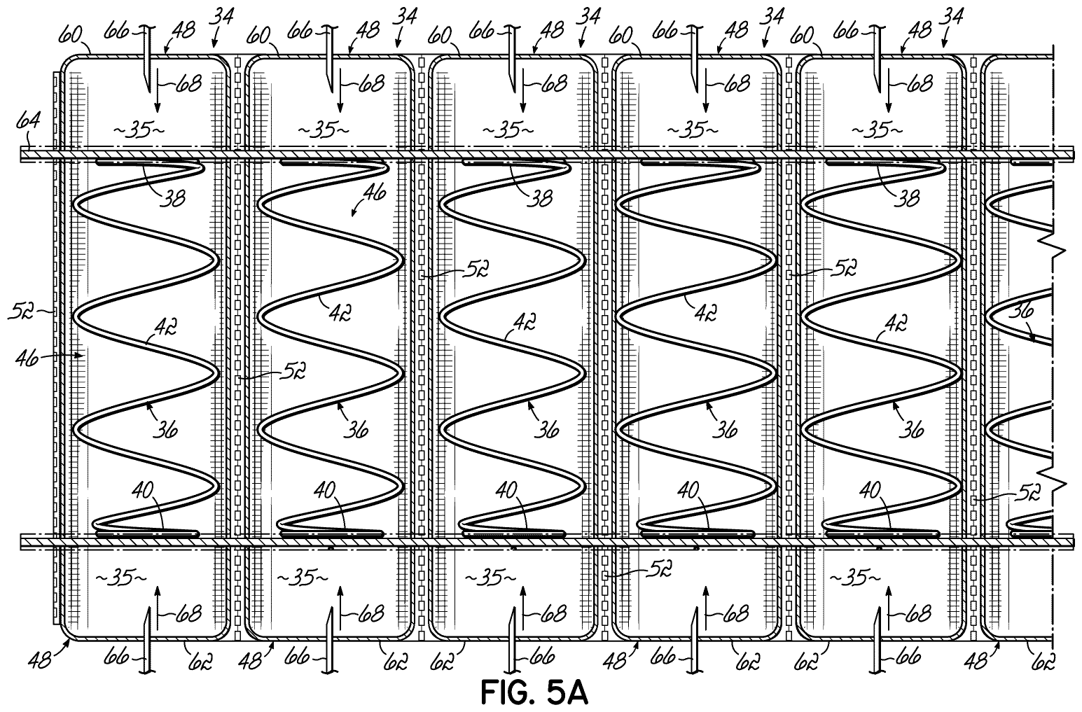

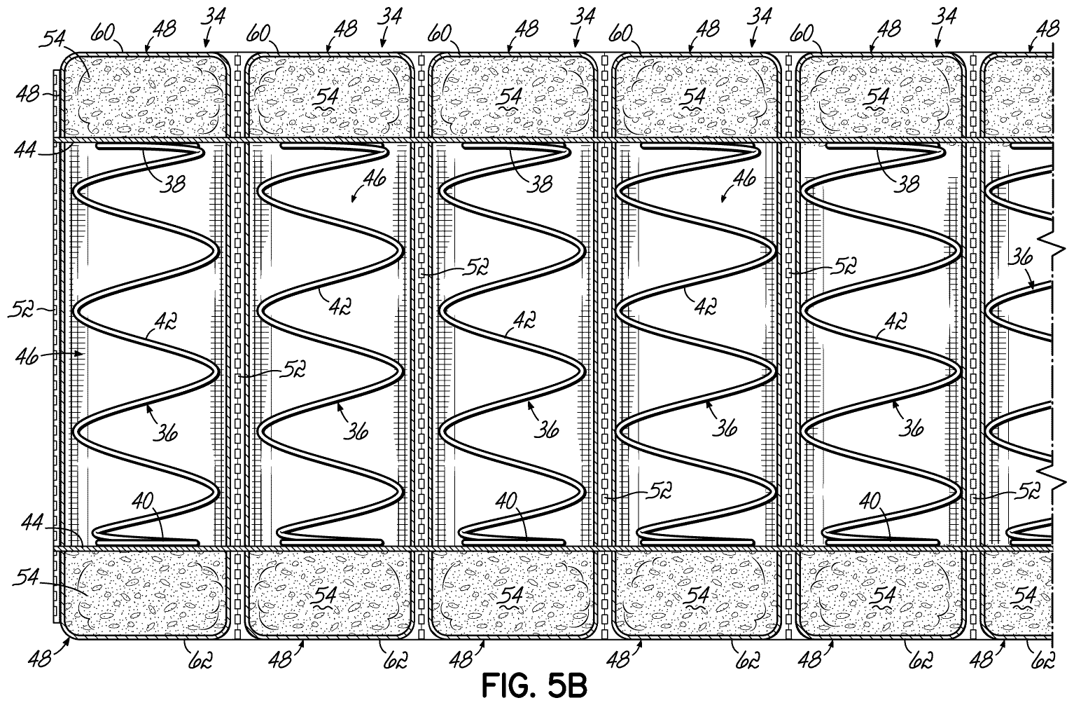

FIG. 1A illustrates a double-sided mattress 10a comprising a pocketed spring assembly 12a. The mattress 10a of FIG. 1A has conventional padding layers 14, 16 above and below a double-sided pocketed spring assembly 12a. The double-sided pocketed spring assembly 12a comprises a plurality of strings 26a of pocketed springs, one being partially shown in cross-section in FIGS. 5A and 5B.

These strings of pocketed springs 26 and 26a, and any other strings of springs described or shown herein, may be connected in side-by-side relationship as, for example, by gluing the sides of the strings together in an assembly machine, to create an assembly or matrix of springs having multiple rows and columns of pocketed springs bound together as by gluing, welding or any other conventional assembly process commonly used to create pocketed spring cores or assemblies.

Referring to FIGS. 1 and 1A, the strings 26, 26a of pocketed springs may be joined so that the individually pocketed springs 28 are aligned in transversely extending rows 30 and longitudinally extending columns 32. Alternatively, the strings 26 of pocketed springs may be offset from one another in a pocketed spring assembly, as disclosed and shown in U.S. Pat. No. 10,842,289, which is fully incorporated by reference herein.

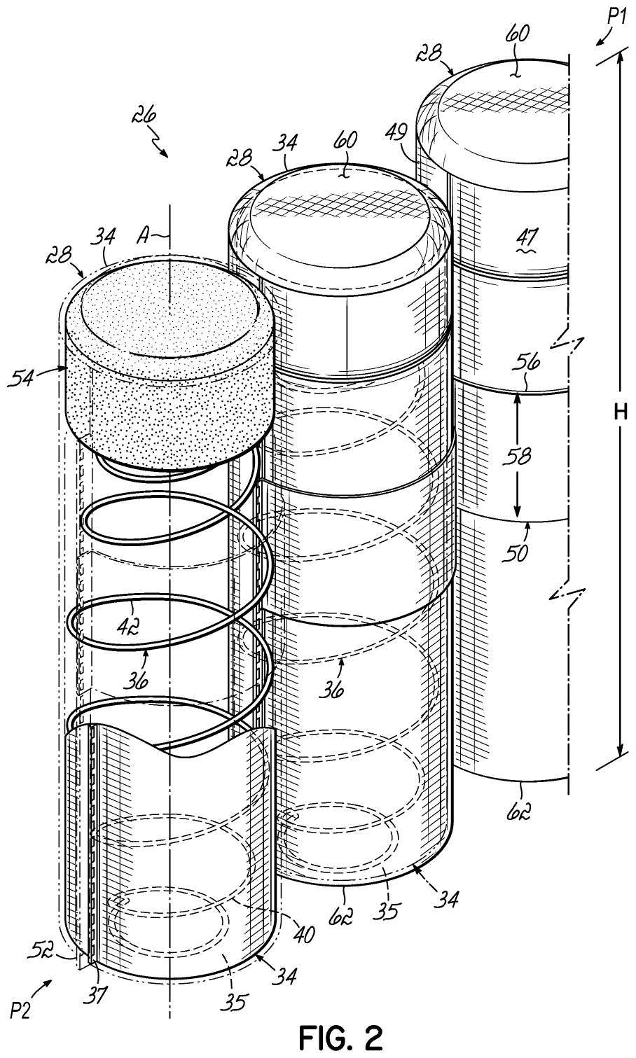

As best illustrated in FIG. 2, each string 26 of pocketed springs 28 comprises a row of interconnected fabric oversized pockets 34. Each of the fabric oversized pockets 34 has an interior 35 which contains at least one coil spring 36 and at least one foam pad 54 separated from each other by a separating seam 44. The separating seam 44 divides the oversized pocket 34 into a spring pocket 46 and a mini-pocket 48. A coil spring 36 is encased in the spring pocket 46 and a foam pad is encased in the mini-pocket 48. Adjacent oversized pockets 34 are separated from each other by transverse seams 52.

FIGS. 2, 3A-4D illustrate a one-sided string 26 for use in a single-sided pocketed spring assembly, such as pocketed spring assembly 12. In string 26, one foam pad 54 rests on the fabric of the separating seam 44 which contains the coil spring 36. In this orientation, the coil spring 36 is prevented from contacting and damaging the material of the foam pad 54.

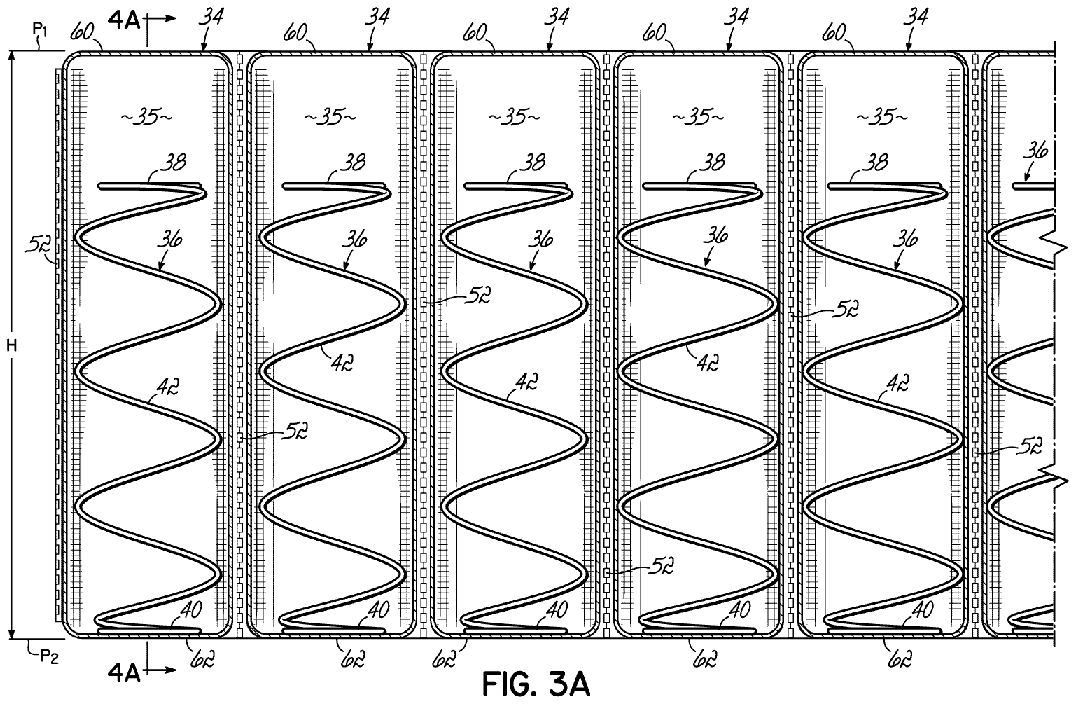

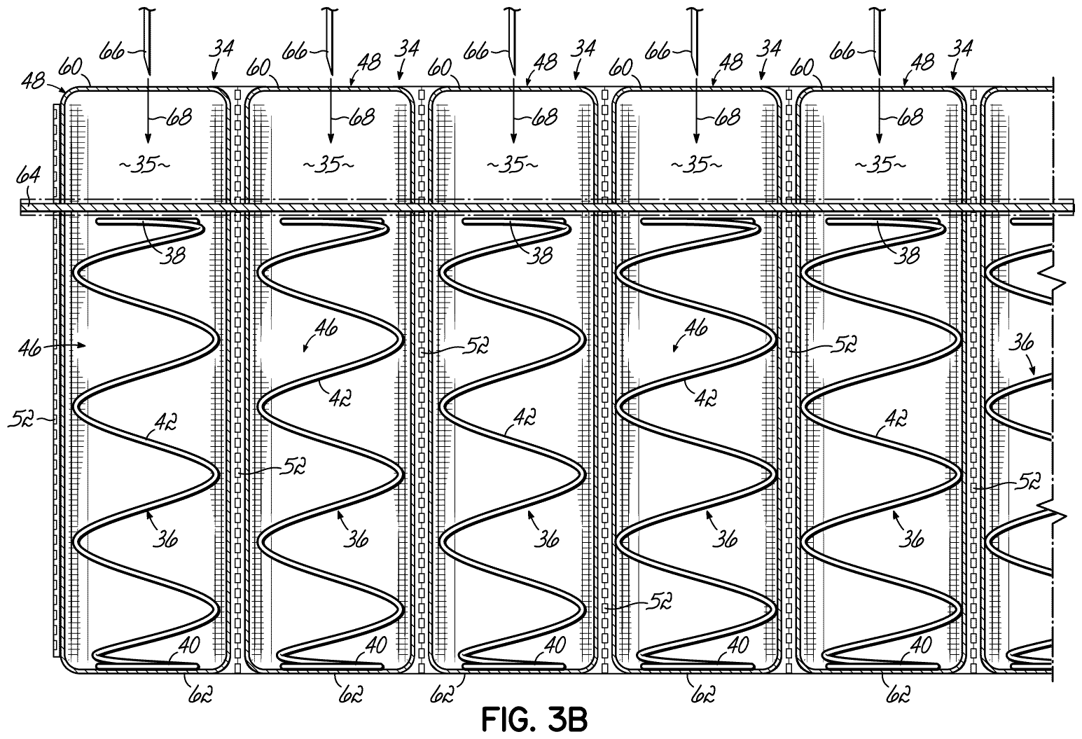

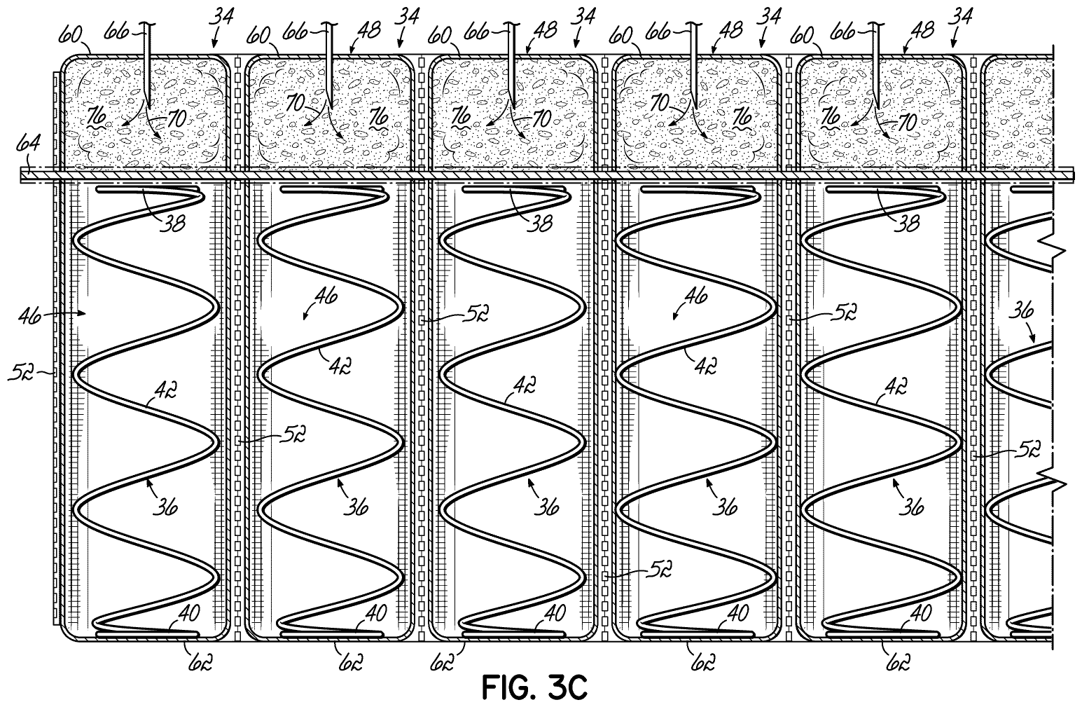

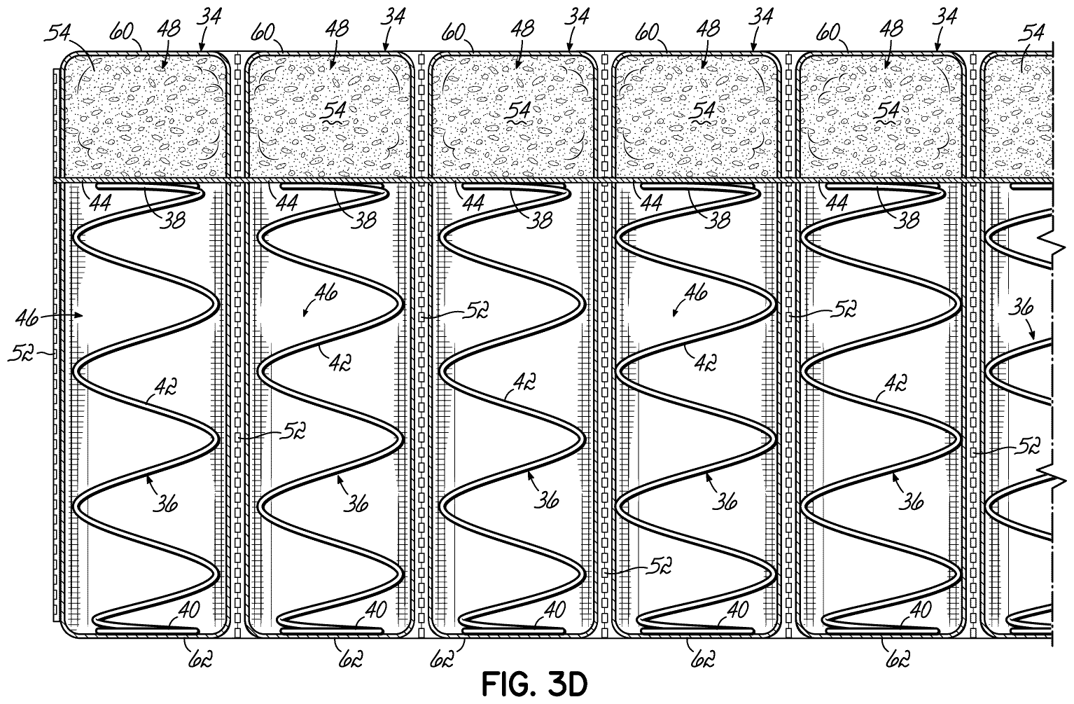

The coil spring 36 is preferably made of one piece of wire of a uniform diameter, but may be made of other materials, multiple strands of twisted wire and/or may be a non-uniform diameter. As best shown in FIG. 2, each coil spring 36 has a central or longitudinal axis A, an upper end turn 38, a lower end turn 40 and a plurality of central convolutions 42 between the end turns. FIGS. 2 and 3A illustrate a barrel-shaped coil spring 36 in which the diameter of the end turns 38, 40 is less than the diameter of the central convolutions 42. Although one configuration of coil spring 36 is illustrated, any other known configuration of coil spring may be used.

Preferably, one piece of fabric is used to create the outer or oversized pockets 34 of the string 26 of pocketed springs 36, the piece of fabric being folded over onto itself around the coil springs 36. As best shown in FIG. 2, opposite sides or plies 47, 49 of the fabric are sewn, welded or otherwise secured together to create a longitudinal seam 50 and a plurality of separating or transverse seams 52. FIG. 2 illustrates ply 47 being closest to the reader and ply 49 being behind the springs 36.

Although the seams or welds in the embodiments shown herein are shown as being welded spaced rectangles, any of the seams may be spaced dots, triangles or solid line segments without spaces.

As best shown in FIG. 2, opposed edges 56 of the piece of fabric used to create the string of pocketed springs 26 are aligned and spaced from the longitudinal seam 50 a distance indicated by numeral 58. Although the drawings indicated the longitudinal seam 50 being below the free edges 56 of the piece of fabric, the longitudinal seam 50 may be above the free edges 56 of the piece of fabric.

As shown in FIGS. 2 and 3A, the string of pocketed springs 26 has a generally planar top surface 60 in a top plane P1 and a parallel generally planar bottom surface 62 in a bottom plane P2. The linear distance between the top and bottom surfaces 60, 62 of the string 26 defines a height H of the string 26. This linear distance further defines the height H of the pocketed spring assembly 12 because each of the strings 26 has the same height. However, it is within the scope of the present invention that different strings of springs of a pocketed spring assembly have different heights.

In accordance with one embodiment, in strings 26, the transverse seams 52 forming the adjacent oversized pockets 34 may be any desired length.

Referring now to FIGS. 1A and 5B, mattress 10a illustrated in FIG. 1A is a double-sided mattress, made of strings 26a shown in FIG. 5B.

FIG. 5B illustrates a portion of a string of springs 26a used in a double-sided pocketed spring assembly, like pocketed spring assembly 12a shown in FIG. 1A. The fabric outer or oversized pockets 34a of such strings 26a are slightly different (larger) than the fabric outer or oversized pockets 34 of string of springs 26.

FIG. 5B illustrates a two-sided string 26a for use in a double-sided pocketed spring assembly 12a, as shown in FIG. 1A. Two foam pads 54 are located inside each oversized pocket 34a along with a coil spring 36 located between the foam pads 54. One of the foam pads 54 is located above the coil spring 36 and the other foam pad 54 is located below the coil spring 36.

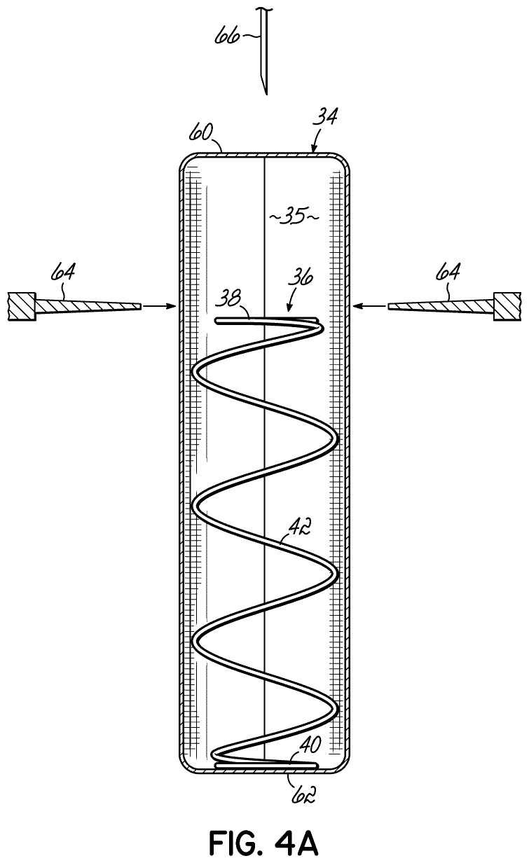

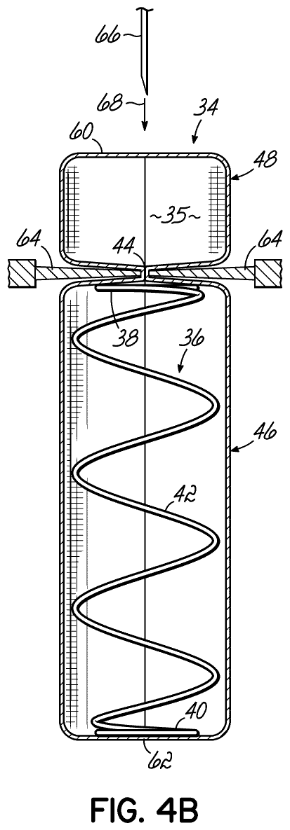

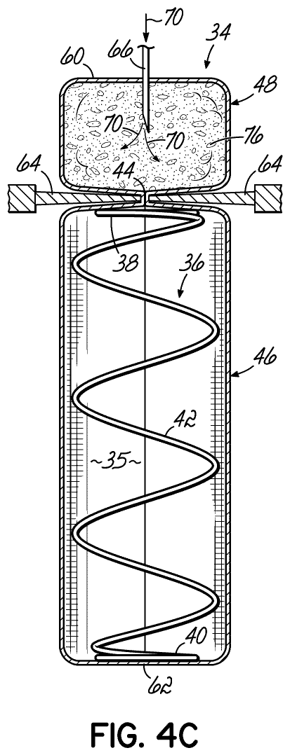

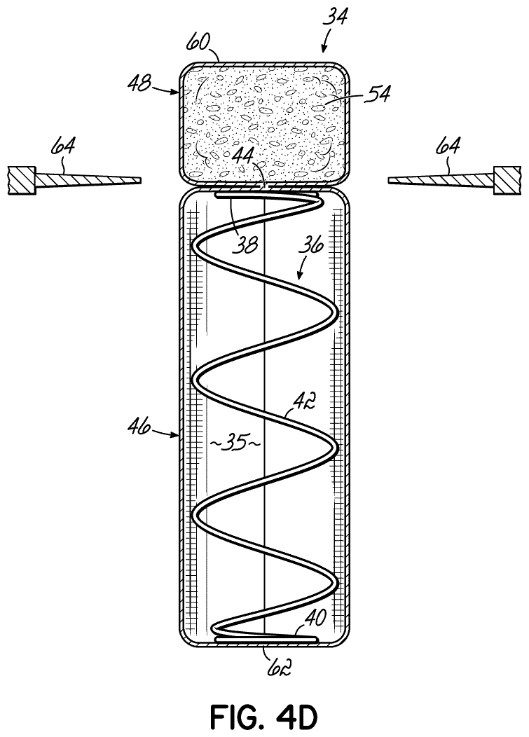

FIGS. 3A to 4D show a method of making a single-sided string 26 for use in pocketed spring assembly 12a. FIG. 3A shows a cross-sectional view of a portion of a single-sided string 26 after the longitudinal seam shown in FIG. 2, and the transverse seams 52 create a plurality of oversized pockets 34. Each of the oversized pockets 34 contains a coil spring 36.

FIGS. 3B and 4A show two welding plates 64 (only one being shown in FIG. 3B) coming together to create a separating seam 44 in each oversized pocket 34. The separating seam 44 is located on one side of the coil springs 36 so that within each oversized pocket 34, the coil spring 36 is located in a spring pocket 46 below the separating seam 44. The separating seam 44 divides each oversized pocket 34 into a spring pocket 46 and a mini-pocket 48 into which a mixture of foam chemicals are injected. FIG. 3B shows a plurality of aligned injector nozzles 66, each injector nozzle 66 being capable of passing through the fabric of the oversized pocket 34. FIG. 3B shows each injector nozzle 66 being lowered as indicated by an arrow 68 but still above the fabric of the oversized pocket 32. FIG. 4B corresponds to FIG. 3B but shows only one oversized pocket 34.

FIG. 3C shows the injector nozzles 66 having passed through the fabric of the oversized pockets 34 and into the mini-pockets 48. As indicated by arrows 70, a mixture of foam chemicals passes though one of the injector nozzles 66 and into the interior of the mini-pocket 48. FIG. 4C corresponds to FIG. 3C but shows only one oversized pocket 34. At this point the welding plates 64 are pushed together to create the separating seams 44. FIGS. 3C and 4C show the mini-pockets 48 filled with a mixture 76 of foam chemicals.

FIG. 3D shows the injector nozzles 66 having been removed from inside the mini-pockets 48. FIG. 4D corresponds to FIG. 3D but shows only one oversized pocket 34. At this point the welding plates 64 have been returned to their home position away from each other after creating the separating seams 44. FIGS. 3D and 4D show the mini-pockets 48 filled with a foam pad 54 hardened from the mixture 76 of foam chemicals.

FIGS. 5A and 5B show a process of making a double-sided string 26a. Instead of one set of movable welding plates 64, two sets of welding plates 64 are used to create two separating seams 44. Within each oversized pocket 34, one separating seam 44 is above the spring pocket 46 and the other separating seam 44 is below the spring pocket 46. FIG. 5A shows injector nozzles 66 entering each of the mini-pockets 48 on opposite sides of the spring pockets 46. FIG. 5B shows foam pads 54 in each of the mini-pockets 48 on opposite sides of the coil springs 36 within the spring pockets 46.

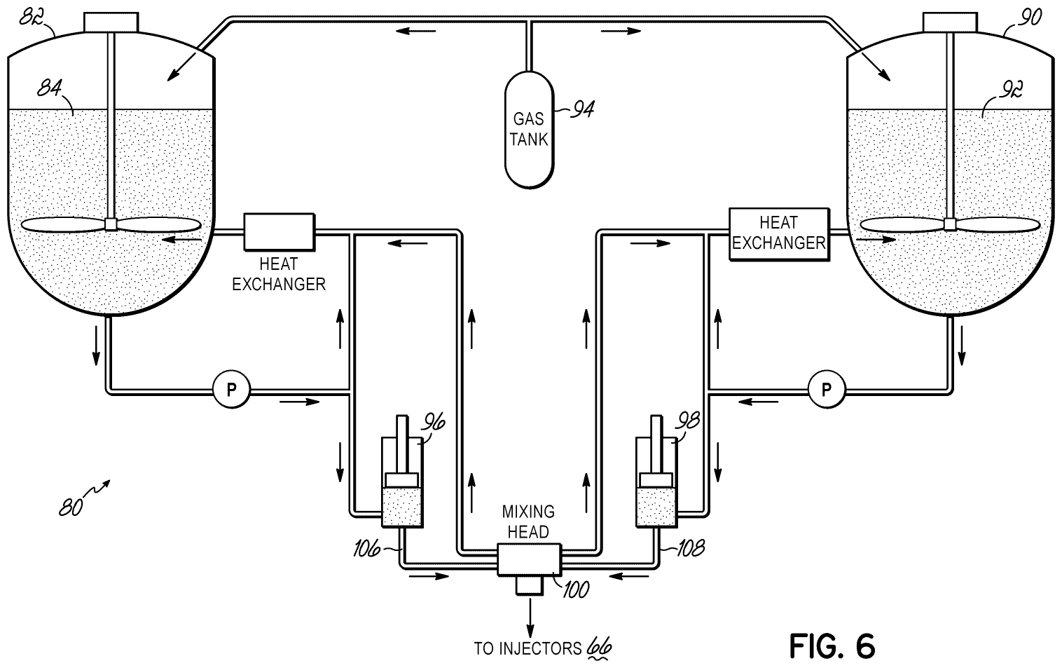

FIG. 6 illustrates an apparatus 80 for creating the mixture 76 of foam chemicals. The apparatus 80 comprises a first tank 82 holding chemical components 84 which may include isocyanate. The apparatus 80 further comprises a second tank 90 holding chemical components 92 which may include polyols. A gas tank 94 may contain nitrogen to mix with the chemical components. The apparatus further comprises a first metering cylinder 96 and a second metering cylinder 98 and a mixing head 100 which passes the mixture 76 of foam chemicals to injector nozzles 66.

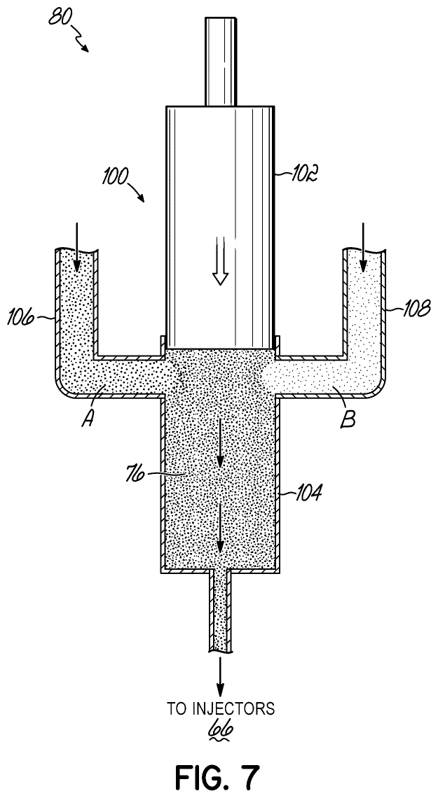

FIG. 7 further illustrates the mixing head 100 of apparatus 80 which includes a piston 102 movable inside a cylinder 104. The piston 102 pushes the mixture 76 of foam chemicals into the injector nozzles 66. The mixture 76 is created by mixing the first group of components A through passage 106 with the second group of components B moving through passage 108.

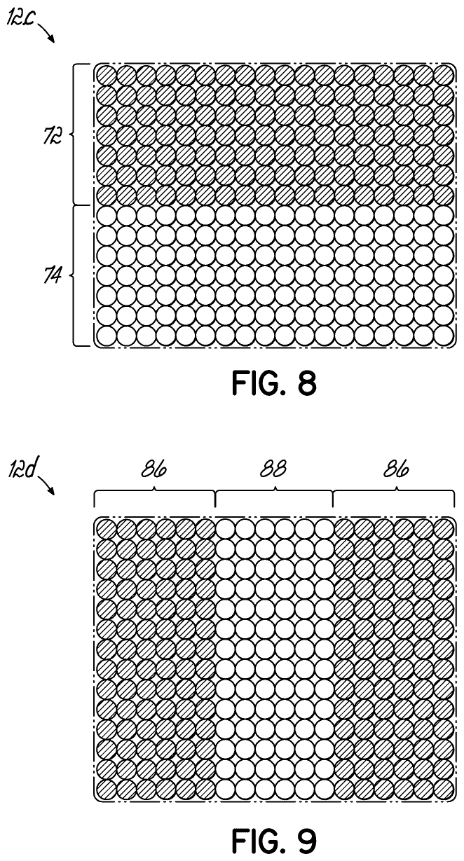

Referring now to FIG. 8, longitudinally extending strings are shown in one preferable arrangement for a spring core for a bedding or seating product, such as a mattress. As can be seen, the longitudinally extending strings are arranged in a plurality of zones on the pocketed spring assembly 12c. By way of example, two zones 72, 74 are illustrated, with the zones corresponding roughly to a “firm” side and a “soft” side. By way of further example, the longitudinally extending strings of the “soft” zone 72 each have a foam pad “softer” than the foam pads of the firm zone 74. The longitudinally extending strings of the “firm” zone 74 are strings having a firmer foam pad than the strings of the “soft” zone 72. Of course, other arrangements are within the scope of the invention. For example, the pocketed spring assembly 12c shown in FIG. 8 may comprise transversely extending strings rather than longitudinally extending strings. In such an arrangement, each transversely extending string would have to be half firm and half soft. Therefore, each string would have only half the string having harder foam pads, the other half having softer foam pads.

Alternatively, one of the zones 72, 74 may be “cooler” than the other zone due to the foam pads having different chemical compositions. For example, the foam pads of one zone may include additives therein while the foam pads of the other zone lack the same additives. Alternatively, the foam pads of the zones may have different additives.

Referring now to FIG. 9, the transversely extending strings are shown in one preferable arrangement for a pocketed spring assembly 12d for a bedding or seating product, such as a mattress. As can be seen, the transversely extending strings are arranged in a plurality of zones on the pocketed spring assembly 12d. By way of example, three zones are illustrated, with the zones corresponding roughly to the location of a sleeper's head and shoulders, mid-section, knees and feet. By way of further example, the two end “soft” zones 86 each comprise strings of springs having softer foam pads than the foam pads of the middle or “firm” zone 88. The transversely extending strings of the middle or “firm” zone 88 are strings having firmer foam pads than the foam pads of the end “soft” zones 86. Of course, other arrangements are within the scope of the invention. For example, the mattress shown in FIG. 9 may comprise longitudinally extending strings rather than transversely extending strings. In such an arrangement, each longitudinally extending string would have to be divided into three sections; a middle “firm” section and two end or “soft” sections. Therefore, each string would have only the end thirds of the string having softer foam pads, the middle third having firmer foam pads.

Alternatively, one of the zones 86, 88 may be “cooler” than the other zone due to the foam pads having different chemical compositions. For example, the foam pads of one zone may include additives therein while the foam pads of the other zone lack the same additives. Alternatively, the foam pads of the zones may have different additives.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. For example, more than two foam pads may be inside an outer pocket. The invention resides in each individual feature described herein, alone, and in all combinations of any and all of those features. Accordingly, the scope of the invention shall be limited only by the following claims and their equivalents.

What is claimed:

1. A method of making a string of springs comprising:
wrapping a piece of fabric around a plurality of springs and joining the piece of fabric to itself with a longitudinal seam, first and second opposed plies of fabric being on opposite sides of the springs, a plurality of pockets formed along said string by transverse seams joining the first and second plies, at least one spring being in each of the pockets;
welding the first and second opposed plies of fabric together to create mini-pockets;
injecting foam chemicals in each of the mini-pockets through the fabric; and
allowing the foam chemicals to react in each of the mini-pockets to create a foam pad in the mini-pocket.

2. The method of claim 1, wherein the foam chemicals include polyols, water, silicone surfactant, amine catalyst, tin catalyst and isocyanate.

3. The method of claim 1, the foam chemicals include additives.

4. The method of claim 1, wherein the springs in the pockets are separated from the mini-pockets.

5. The method of claim 1, further comprising injecting additives into at least some of the mini-pockets through the fabric.

6. The method of claim 1, wherein injecting foam chemicals into each of the mini-pockets through the fabric comprises injecting the same foam chemicals into each of the mini-pockets.

7. The method of claim 1, wherein injecting foam chemicals into each of the mini-pockets through the fabric comprises injecting different foam chemicals into different mini-pockets.

8. A method of making a string of springs comprising:
wrapping a piece of fabric around a plurality of coil springs and joining the piece of fabric together with a longitudinal seam, first and second opposed plies of fabric being on opposite sides of the coil springs;
welding the first and second opposing plies along transverse seams to create a plurality of oversized pockets, a coil spring being in each of the oversized pockets;
welding the first and second opposing plies of fabric together in a direction parallel the longitudinal seam to create separating seams, thereby separating the oversized pocket into a spring pocket and a mini-pocket;
injecting a mixture of foam chemicals into the mini-pocket through the fabric; and
allowing the mixture of foam chemicals to react in the mini-pocket to create a foam pad in the mini-pocket without entering the spring pocket.

9. The method of claim 8, wherein the foam chemicals include polyols, water, silicone surfactant, amine catalyst, tin catalyst and isocyanate.

10. The method of claim 8, wherein the mixture of foam chemicals further comprises additives.

11. The method of claim 8, wherein the mixture of foam chemicals further comprises blowing agents.

12. The method of claim 8, wherein said longitudinal seam is a side seam.

13. The method of claim 8, wherein injecting the mixture of foam chemicals into each of the mini-pockets through the fabric comprises injecting the same mixture of foam chemicals into each of the mini-pockets.

14. The method of claim 8, wherein injecting the mixture of foam chemicals into each of the mini-pockets through the fabric comprises injecting different mixtures of foam chemicals into different mini-pockets.

15. A method of making a string of springs comprising:
wrapping a piece of fabric around a plurality of springs and joining the piece of fabric together with a longitudinal seam, first and second opposed plies of fabric being on opposite sides of the springs;
welding the first and second opposing plies together to create transverse seams, the transverse seams separating the piece of fabric into a plurality of oversized pockets, a spring being in each of the oversized pockets;
further welding the first and second opposing plies of fabric together to create separating seams, thereby separating the oversized pocket into a spring pocket containing the spring and an empty mini-pocket;
injecting foam chemicals into the mini-pocket through the fabric; and
allowing the foam chemicals to react in the mini-pocket to create a foam pad in the mini-pocket.

16. The method of claim 15, wherein the foam chemicals include polyols, water, silicone surfactant, amine catalyst, tin catalyst, blowing agents and isocyanate.

17. The method of claim 15, further comprising injecting additives into at least some of the mini-pockets through the fabric.

18. The method of claim 15, wherein creating the separating seams comprises welding the first and second opposing plies of fabric together in a direction parallel the longitudinal seam.

19. The method of claim 15, wherein injecting foam chemicals into each of the mini-pockets through the fabric comprises injecting the same foam chemicals into each of the mini-pockets.

20. The method of claim 15, wherein injecting foam chemicals into each of the mini-pockets through the fabric comprises injecting different foam chemicals into different mini-pockets.
